(19) United States
(12) Patent Application Publication
(10) Pub. No.: US 2016/0340610 A1
(43) Pub. Date: Nov. 24, 2016

(54) METHOD FOR STABILIZING A SOFTENING COMPOSITION

(71) Applicant: RHODIA OPERATIONS, Paris (FR)

(72) Inventors: Hai Zhou ZHANG, Singapore (SG); Lin HE, Singapore (SG); Nikolay CHRISTOV, Singapore (SG)

(21) Appl. No.: 15/111,600

(22) PCT Filed: Jan. 16, 2015
(86) PCT No.: PCT/EP2015/050786

§ 371 Date: Jul. 14, 2016

(30) Foreign Application Priority Data
Jan. 17, 2014 (EP) 14151645.0

(51) Int. Cl. C11D 1/00; C11D 1/62; C11D 3/00

(52) U.S. Cl. CPC C11D 1/008; C11D 3/001; C11D 1/62

(57) ABSTRACT

The present invention relates to a method for enhancing the stability of a composition comprising the steps of adding in the composition at least a fabric conditioning compound and a cationic polysaccharide. The resulting composition has excellent stability and long storage life, as well as, superior conditioning performance.

This application claims priority to European application No. 14151645.0 filed on Jan. 17, 2014, the whole content of this application being incorporated herein by reference for all purposes.

### TECHNICAL FIELD

The present invention relates to a stable and homogenous composition, particularly, a fabric conditioning composition, comprising at least a fabric conditioning compound, preferably, a biodegradable and cationic fabric conditioning compound, and a cationic polysaccharide. The composition has excellent stability and long storage life, as well as, superior softening performance.

### BACKGROUND ART

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Fabric conditioning compositions can be added in the rinse cycle of the laundering process to soften fabrics and to impart them nice smell. Conventionally, fabric conditioning systems are based on quaternary ammonium compounds, also named as quats, notably cetrimonium chloride, behentrimonium chloride, N,N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2-hydroxyethyl)N-methyl ammonium methylsulfate or 1,2-di(stearoyl-oxy)-3-trimethyl ammoniumpropane chloride.

However, quats are known difficult to be bio-degraded and thus exhibit eco toxicity. There is a general trend in the industry to switch to other conditioning systems. One option is to use ester quats which provide better biodegradability and lower eco toxicity.

The art also teaches that addition of cationic polymers to fabric conditioning compositions has a variety of benefits. U.S. Pat. No. 6,492,322, Megan et al., discloses fabric softening compositions comprising biodegradable diester softening compounds and cationic polymers including polysaccharides, such as gums, starches and certain cationic synthetic polymers.

One problem of fabric conditioning compositions comprising biodegradable ester quats is the long term stability, that is to say after long time storage, such compositions become unpourable and have inadequate dispensing and dissolving characteristics in rinse water. One reason for such disadvantage is the hydrolysis of the biodegradable ester quats. One option to solve this problem is to lower the ester quat dosage level in the composition by replacing some of the ester quats with a cationic polymer, such as a cationic polysaccharide. By doing this, the stability of the compositions can be improved and the softening performance can be maintained as well. But replacing some of the ester quats with a cationic polysaccharide in the fabric conditioning compositions will lead to another problem. More specifically, the combination of the ester quat and the cationic polysaccharide tends to separate, as a result, the fabric conditioning compositions are no longer homogeneous and segregate into different phases. This may pose problems to the user upon usage or may affect retailers when placing products on the shelves, without mentioning any associated loss of performance for the softening products.

There is a need to provide a method for preparing a stable fabric conditioning composition which can remain homogenous and has minimal tendency of phase segregation, providing then an excellent stability and viscosity characteristics upon prolonged storage, and which overcome the drawbacks associated with the know fabric conditioning compositions.

### SUMMARY OF INVENTION

It has now been found that the above objective can be met by the present invention.

In accordance with a first aspect of the present invention, there is provided a method for enhancing the stability of a composition, particularly, a fabric conditioning composition, comprising the steps of adding in the composition:
a) a quaternary ammonium compound; and
b) a cationic polysaccharide, the cationic polysaccharide having a charge density in the range of 0.8 to 3 meq/gm;
wherein the weight ratio of compound a) to compound b) is in the range of 1:1 to 15:1.

In one embodiment, the compound b) has a charge density in the range of 0.8 to 1.6 meq/gm.

In another embodiment, the compound b) has a charge density in the range of 0.9 to 1.4 meq/gm.

In still another embodiment, the weight ratio of the compound a) to the compound b) is in the range of 3:1 to 14:1.

In still another embodiment, the weight ratio of the compound a) to the compound b) is in the range of 4:1 to 13:1.

In still another embodiment, the weight ratio of the compound a) to the compound b) is in the range of 4:1 to 7:1.

In still another embodiment, the compound a) has the general formula (I):

[N⁺(R₁)(R₂)(R₃)(R₄)]_{y}X⁻ (I)
wherein:
R¹, R², R³ and R⁴, which may be the same or different, is a C₁-C₃₀ hydrocarbon group, optionally containing a heteroatom or an ester or amide group,
X is an anion,
y is the valence of X.

In still another embodiment, the compound a) has the general formula (II):

[N⁺(R₅)₂(R₆)(R₇)]_{y}X⁻ (II)
wherein:
R⁵ is an aliphatic C₁₆₋₂₂ group,
R⁶ is a C₁-C₃ alkyl group,
R⁷ is R⁵ or R⁶,
X is an anion,
y is the valence of X.

In still another embodiment, the compound a) has the general formula (III)

[N⁺((CH₂)ₙ-T-R₈)₂(R₈)(R₉)]X⁻ (III)
wherein:
R⁹ group is independently selected from C₁-C₄ alkyl or hydroxylalkyl group,
R⁸ group is independently selected from C₁-C₃₀ alkyl or alkenyl group,
is —C(═O)—O—,
n is an integer from 0 to 5,
X is an anion.

In still another embodiment, the compound a) may have the general formula (IV):

N⁺(C₂H₄—OOCR₁₀)₂(CH₃)(C₂H₄—OH)CH₃SO₄⁻ (IV)
wherein R₁₀ is a C₁₂-C₂₀ alkyl chain.

Preferably, the compound a) may be chosen from the group consisting of:
TET: Di(tallowcarboxyethyl)hydroxyethyl methyl ammonium methylsulfate
TEO: Di(oleocarboxyethyl)hydroxyethyl methyl ammonium methylsulfate,
TES: Distearyl hydroxyethyl methyl ammonium methylsulfate,
TEHT: Di(hydrogenated tallow-carboxyethyl)hydroxyethyl methyl ammonium methylsulfate,
TEP: Di(palmiticcarboxyethyl)hydroxyethyl methyl ammonium methylsulfate,
DEEDMAC: Dimethylbis[2-[(1-oxooctadecyl)oxy]ethyl]ammonium chloride
DHT: Dihydrogenated tallowdimethylammonium chloride

Preferably, the compound b) is a cationic guar.

Preferably, the compound b) is a guar hydroxypropyltrimonium chloride or a hydroxypropyl guar hydroxypropyltrimonium chloride.

In still another embodiment, the composition comprises from 0.2 wt % to 2 wt % of the compound b) of the total weight of the composition.

In still another embodiment, the compound b) has an average molecular weight (Mw) of between 1,500,000 daltons and 3,500,000 daltons.

In still another embodiment, the composition, when kept at 45° C., does not show phase separation for at least 4 weeks.

Other advantages and more specific properties of the method according to the present invention will be clear after reading the following description of the invention.

### DETAILED DESCRIPTION

Throughout the description, including the claims, the term “comprising one” should be understood as being synonymous with the term “comprising at least one”, unless otherwise specified, and “between” should be understood as being inclusive of the limits.

In the context of this invention, “textile care agent” is understood to mean both washing and cleaning agents and pretreatment agents, as well as agents for conditioning textile fabrics such as delicate fabric washing agents, and post-treatment agents such as conditioners.

In the context of this invention, the term “fabric conditioning” is used herein the broadest sense to include any conditioning benefit(s) to textile fabrics, materials, yarns, and woven fabrics. One such conditioning benefit is softening fabrics. Other non-limiting conditioning benefits include, enhanced shine and color brilliance, freshness, perfume, a decrease in creasing and static charge, reduction of abrasion, garment shape retention, reduction of wrinkles, color care, color maintenance, whiteness maintenance, pilling reduction, or any combination thereof.

“Alkyl” as used herein means a straight chain or branched saturated aliphatic hydrocarbon group. “Alkenyl”, as used herein, refers to an aliphatic group containing at least one double bond and is intended to include both “unsubstituted alkenyls” and “substituted alkenyls”, the latter of which refers to alkenyl moieties having substituents replacing a hydrogen on one or more carbon atoms of the alkenyl group.

The term “cationic polymer” is used herein the broadest sense to include any polymer which has a cationic charge.

In the context of the present invention, the term “phase segregation” refers to that the compositions separate into different phases and are no longer homogeneous, wherein active ingredients of the compositions, such as quaternary ammonium compounds and cationic polysaccharides, form macroscopic aggregates which are separated from the homogeneous liquid phase of the compositions.

In one aspect of the present invention there is provided a method for enhancing the stability of a composition, particularly, a fabric conditioning composition, comprising the steps of adding in the composition:
a) a quaternary ammonium compound; and
b) a cationic polysaccharide, the cationic polysaccharide having a charge density in the range of 0.8 to 3 meq/gm;
wherein the weight ratio of compound a) to compound b) is in the range of 1:1 to 15:1.

Notably, the composition, when kept at 45° C., does not show phase separation for at least 4 weeks.

Preferably, the quaternary ammonium compound is water dispersible.

The quaternary ammonium compounds of the present invention may be those ones of the general formula (I):

[N⁺(R₁)(R₂)(R₃)(R₄)]_{y}X⁻ (I)
wherein:
R¹, R², R³ and R⁴, which may be the same or different, is a C₁-C₃₀ hydrocarbon group, typically an alkyl, hydroxyalkyl or ethoxylated alkyl group, optionally containing a heteroatom or an ester or amide group,
X is an anion, for example halide such as Cl or Br, sulphate, alkyl sulphate and acetate,
y is the valence of X.

The quaternary ammonium compounds are preferably alkyl quat, such as dialkyl quat, or ester quat such as a dialkyl diester quat.

The dialkyl quat may be a compound of general formula (II):

[N⁺(R₅)₂(R₆)(R₇)]_{y}X⁻ (II)
wherein:
R⁵ is an aliphatic C₁₆₋₂₂ group,
R⁶ is a C₁-C₃ alkyl group,
R⁷ is R⁵ or R⁶,
X is an anion, for example halide such as Cl or Br, sulphate, alkyl sulphate and acetate,
y is the valence of X.

The dialkyl quat is preferably di-(hardened tallow) dimethyl ammonium chloride.

In one embodiment of the present invention, the quaternary ammonium compounds are compounds of formula (III):

[N⁺((CH₂)ₙ-T-R₈)₂(R₈)(R₉)]X⁻ (III)
wherein:
R⁹ group is independently selected from C₁-C₄ alkyl or hydroxylalkyl group,
R⁸ group is independently selected from C₁-C₃₀ alkyl or alkenyl group,
T is —C(═O)—O—,
n is an integer from 0 to 5,
X is an anion, for example a chloride, bromide or methosulphate ion.

Preferably, the quaternary ammonium compounds comprise two C₁₂₋₂₈ alkyl or alkenyl groups connected to the nitrogen head group, more preferably via at least one ester link. Even more preferably, the quaternary ammonium compounds have two ester links present.

Preferably, the average chain length of the alkyl or alkenyl group is at least C₁₄, more preferably at least C₁₆. Most preferably at least half of the chains have a length of C₁₈.

It is generally preferred that the alkyl or alkenyl chains are predominantly linear, although a degree of branching, especially mid-chain branching, is within the scope of the invention.

The ester quaternary ammonium compounds may be triethanolamine-based quaternary ammonium of formula (IV):

N⁺(C₂H₄—OOCR₁₀)₂(CH₃)(C₂H₄—OH)CH₃SO₄⁻ (IV)
wherein R₁₀ is a C₁₂-C₂₀ alkyl chain.

Preferred ester quaternary ammonium compounds of the present invention are:
TET: Di(tallowcarboxyethyl)hydroxyethyl methyl ammonium methylsulfate,
TEO: Di(oleocarboxyethyl)hydroxyethyl methyl ammonium methylsulfate,
TES: Distearyl hydroxyethyl methyl ammonium methylsulfate,
TEHT: Di(hydrogenated tallow-carboxyethyl)hydroxyethyl methyl ammonium methylsulfate,
TEP: Di(palmiticcarboxyethyl)hydroxyethyl methyl ammonium methylsulfate,
DEEDMAC: Dimethylbis[2-[(1-oxooctadecyl)oxy]ethyl]ammonium chloride,
DHT: Dihydrogenated tallowdimethylammonium chloride.

The quaternary ammonium compound of the present invention is optionally present in an amount of from 0.1 to 15 wt %, preferably from 1 to 10 wt %, more preferably from 2 to 5 wt %, based on the total weight of the composition.

According to one aspect of the present invention, the method also comprises adding in the composition, particularly the fabric conditioning composition, at least one cationic polysaccharide.

Within the context of the present invention, the cationic polysaccharides may be selected from polymers having a polysaccharide backbone comprising cationic groups.

The cationic polysaccharides can be obtained by chemically modifying polysaccharides, generally natural polysaccharides. This chemical modification, also known as “derivatization”, makes it possible to introduce side groups into the polysaccharide backbone.

Preferably, the cationic groups borne by the cationic polysaccharides according to the present invention are quaternary ammonium groups.

The cationic polysaccharide may be selected from the group consisting of: cationic guar, cationic cellulose, cationic callose, cationic xylan, cationic mannan and cationic galactomannan.

Guars are polysaccharides composed of the sugars galactose and mannose. The backbone is a linear chain of β 1,4-linked mannose residues to which galactose residues are 1,6-linked at every second mannose, forming short side-branches.

Within the context of the present invention, the cationic guars are cationic derivatives of guars.

In the case of the cationic polysaccharides, such as the cationic guars, the cationic group may be a quaternary ammonium group bearing 3 radicals, which may be identical or different, preferably chosen from hydrogen, alkyl, hydroxyalkyl, epoxyalkyl, alkenyl, or aryl, preferably containing 1 to 22 carbon atoms, more particularly 1 to 14 and advantageously 1 to 3 carbon atoms. The counterion is generally a halogen. One example of the halogen is chlorine.

Examples of the quaternary ammonium salts include: 3-chloro-2-hydroxypropyl trimethyl ammonium chloride (CHPTMAC), 2,3-epoxypropyl trimethyl ammonium chloride (EPTAC), diallyldimethyl ammonium chloride (DMDAAC), vinylbenzene trimethyl ammonium chloride, trimethylammonium ethyl metacrylate chloride, methacrylamidopropyltrimethyl ammonium chloride (MAPTAC), and tetraalkylammonium chloride.

One example of the cationic functional group in the cationic polysaccharides is trimethylamino(2-hydroxyl)propyl, with a counter ion. Various counter ions can be utilized, including but not limited to halides, such as chloride, fluoride, bromide, and iodide, sulfate, methylsulfate, and mixtures thereof.

The cationic guars of the present invention may be chosen from the group consisting of:
cationic hydroxyalkyl guars, such as cationic hydroxyethyl guar (HE guar), cationic hydroxypropyl guar (HP guar), cationic hydroxybutyl guar (HB guar), and
cationic carboxylalkyl guars including cationic carboxymethyl guar (CM guar), cationic alkylcarboxy guars such as cationic carboxylpropyl guar (CP guar) and cationic carboxybutyl guar (CB guar), carboxymethylhydroxypropyl guar (CMHP guar).

More preferably, the cationic guars of the present invention are guars hydroxypropyltrimonium chloride or hydroxypropyl guar hydroxypropyltrimonium chloride.

The Degree of Substitution (DS) of cationic polysaccharides, such as cationic guars, is the average number of hydroxyl groups substituted per sugar unit. DS may notably be determined by titration.

According to one aspect of the present invention, the DS of the cationic polysaccharides, such as the cationic guars, is in the range of 0.1 to 1, preferably, from 0.13 to 1, more preferably, from 0.15 to 1, even more preferably, from 0.16 to 0.3.

The Charge Density (CD) of cationic polysaccharides, such as cationic guars, refers to the ratio of the number of positive charges on a monomeric unit of which a polymer is comprised to the molecular weight of said monomeric unit.

It has been found that the charge density of the cationic polysaccharides, such as the cationic guars, affect the stability and tendency of phase segregation of the compositions thereof. According to one aspect of the present invention, the charge density of the cationic polysaccharides, such as the cationic guars, is in the range of 0.5 to 3 (meq/gm), preferably, 0.8 to 2 (meq/gm), more preferably, 0.8 to 1.6 (meq/gm), particularly 0.9 to 1.4 (meq/gm).

Surprisingly, it has also been found that the stability of the compositions, particularly, the fabric conditioning compositions, can be improved by controlling the weight ratio of the quaternary ammonium compounds and the cationic polysaccharides in the compositions.

According to one aspect of the present invention, the weight ratio of the quaternary ammonium compounds and the cationic polysaccharides added to the composition may be in the range of 1:1 to 15:1, preferably 3:1 to 14:1, more preferably, 4:1 to 13:1 (including 4:1, 5:1, 6:1, 7:1, 8:1, 9:1, 10:1, 11:1, 12:1, 13:1 etc., and all values and subranges between stated values as if explicitly written out), even more preferably, 4:1 to 7:1 (including 4:1, 5:1, 6:1, 7:1 etc., and all values and subranges between stated values as if explicitly written out).

The cationic polysaccharides may have an average Molecular Weight (Mw) of between about 100,000 daltons and 3,500,000 daltons, preferably between about 500,000 daltons and 3,500,000 daltons, more preferably between 1,500,000 daltons and 3,500,000 daltons.

The composition, particularly, the fabric conditioning composition, may comprise from 0.05 to 10 wt % of the cationic polysaccharide according to the present invention, preferably, from 0.05 to 5 wt %, more preferably, from 0.1 to 3.5 wt %, even more preferably, from 0.2 to 2 wt %.

According to one aspect of the present invention there is provided a method for enhancing the stability of a composition, particularly, a fabric conditioning composition, comprising the steps of adding in the composition:
a) 0.1 to 10 wt % of the quaternary ammonium compound; and
b) 0.05 to 10 wt % of the cationic polysaccharide, the polysaccharide having a charge density in the range of 0.8 to 2 meg/gram;
wherein the weight ratio of compound a) to compound b) is in the range of 1:1 to 15:1.

More preferably, there is provided a method for enhancing the stability of a composition, particularly, a fabric conditioning composition, comprising the steps of adding in the composition:
a) 0.1 to 10 wt % of the quaternary ammonium compound; and
b) 0.05 to 10 wt % of the cationic polysaccharide, the cationic polysaccharide having a charge density in the range of 0.8 to 1.6 meg/gram;
wherein the weight ratio of compound a) to compound b) is in the range of 3:1 to 14:1.

Even more preferably, there is provided a method for enhancing the stability of a composition, particularly, a fabric conditioning composition, comprising the steps of adding in the composition:
a) 0.1 to 10 wt % of the quaternary ammonium compound; and
b) 0.05 to 10 wt % of the cationic polysaccharide, the cationic polysaccharide having a charge density in the range of 0.9 to 1.4 meg/gram;
wherein the weight ratio of compound a) to compound b) is in the range of 4:1 to 13:1.

Still more preferably, there is provided a method for enhancing the stability of a composition, particularly, a fabric conditioning composition, comprising the steps of adding in the composition:
a) 0.1 to 10 wt % of the quaternary ammonium compound; and
b) 0.05 to 10 wt % of the cationic polysaccharide, the cationic polysaccharide having a charge density in the range of 0.9 to 1.4 meg/gram;
wherein the weight ratio of compound a) to compound b) is in the range of 4:1 to 7:1.

According to one aspect, the present invention is based upon the surprising discovery that the compositions, particularly the fabric conditioning compositions, of the present invention exhibit improved product stability upon prolonged storage. The expression “prolonged storage” means a composition of the present invention is stored for at least one month, preferably for at least three months at temperatures up to 45° C.

According to another aspect of the present invention, the method may comprise adding in the composition one or more of the following optional ingredients: perfumes, dispersing agents, stabilizers, pH control agents, colorants, brighteners, fatty alcohols, fatty acids, dyes, odor control agent, pro-perfumes, cyclodextrins, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and mixtures thereof.

In referring to other optional components, without this having to be regarded as an exhaustive description of all possibilities, which, on the other hand, are well known to the person skilled in the art, the following may be mentioned:
a) other products that enhance the performance of the softening compositions, such as silicones, amine oxides, anionic surfactants, such as lauryl ether sulphate or lauryl sulphate, sulphosuccinates, amphoteric surfactants, such as amphoacetate, nonionic surfactants such as polysorbate, polyglucoside derivatives, and cationic polymers such as polyquaternium, etc,
b) stabilising products, such as salts of amines having a short chain, which are quaternised or non-quaternised, for example of triethanolamine, N-methyldiethanolamine, etc., and also non-ionic surfactants, such as ethoxylated fatty alcohols, ethoxylated fatty amines, polysorbate, and ethoxylated alkyl phenols; typically used at a level of from 0 to 15% by weight of the composition,
c) products that improve viscosity control, for example inorganic salts, such as calcium chloride, magnesium chloride, calcium sulphate, sodium chloride, etc.; products which can be used improve the stability in concentrated compositions, such as compounds of the glycol type, such as, glycerol, polyglycerols, ethylene glycol, polyethylene glycols, dipropylene glycol, other polyglycols, etc.; and thickening agents for diluted compositions, for example, polymers derived from cellulose, guar gum, etc,
d) components for adjusting the pH, which is preferably from 2 to 6, such as any type of inorganic and/or organic acid, for example hydrochloric, sulphuric, phosphoric, citric acid etc,
e) agents that improve soil release, such as the known polymers or copolymers based on terephthalates,
f) bactericidal preservative agents,
g) other products such as antioxidants, colouring agents, perfumes, germicides, fungicides, anti-corrosive agents, anti-crease agents, opacifiers, optical brighteners, pearl lustre agents, etc.

When in a liquid form, the composition prepared by the method of the present invention may contain from 0.1% to 20% by weight of a fabric softening agent, in the case of standard (diluted) fabric softener but may contain higher levels from up to 30% or even 40% by weight in the case of very concentrated fabric softeners. The composition will usually also contain water and other additives, which may provide the balance of the composition. Suitable liquid carriers are selected from water, organic solvents and mixtures thereof. The liquid carrier employed in the instant compositions is preferably at least primarily water due to its low cost, safety, and environmental compatibility. Mixtures of water and organic solvent may be used. Preferred organic solvents are; monohydric alcohol, such as ethanol, propanol, iso-propanol or butanol; dihydric alcohol, such as glycol; trihydric alcohols, such as glycerol, and polyhydric (polyol) alcohols.

Generally, the method may be conducted by melting the softening ingredients and adding the melt to hot water, with agitation to homogenize and disperse the water-insoluble ingredients.

The compositions, notably the fabric conditioning compositions, prepared by the method of the present invention can be used in a so-called rinse process. Typically the fabric conditioning compositions are added during the rinse cycle of an automatic laundry machine.

The composition prepared by the method of the present invention can be used in a so-called rinse process, where the composition is first diluted in an aqueous rinse bath solution. Subsequently, the laundered fabrics which have been washed with a detergent liquor and optionally rinsed in a first inefficient rinse step (“inefficient” in the sense that residual detergent and/or soil may be carried over with the fabrics), are placed in the rinse solution with the diluted composition. Of course, the composition may also be incorporated into the aqueous bath once the fabrics have been immersed therein. Following that step, agitation is applied to the fabrics in the rinse bath solution causing the suds to collapse, and residual soils and surfactant is to be removed. The fabrics can then be optionally wrung before drying.

This rinse process may be performed manually in basin or bucket, in a non-automated washing machine, or in an automated washing machine. When hand washing is performed, the laundered fabrics are removed from the detergent liquor and wrung out. The composition prepared by the method of the present invention may be then added to fresh water and the fabrics are then, directly or after an optional inefficient first rinse step, rinsed in the water containing the composition according to the conventional rinsing habit. The fabrics are then dried using conventional means.

Should the disclosure of any patents, patent applications, and publications which are incorporated herein by reference conflict with the description of the present application to the extent that it may render a term unclear, the present description shall take precedence.

The following examples are included to illustrate embodiments of the invention. Needless to say, the invention is not limited to the described examples.

### EXAMPLES

The compositions in the following samples were prepared by using the materials and procedure as described below:

Materials
Ester quat: TEP: Di(palmiticcarboxyethyl)hydroxyethyl methyl ammonium methylsulfate; Fentacare® TEP softener (from Solvay Novecare);
JAGUAR® C17 guar: Guar hydroxypropyltrimonium chloride, (from Solvay Novecare);
JAGUAR® C14S guar: Guar hydroxypropyltrimonium chloride, (from Solvay Novecare);
JAGUAR® C500 guar: Guar hydroxypropyltrimonium chloride, (from Solvay Novecare);
Jaguar® C162 guar: Hydroxypropyl guar hydroxypropyltrimonium chloride (from Solvay Novecare).

The properties of the above JAGUAR® series guar products are as below:

TABLE 1

| | Degree of | Charge Density | Mw |
|---|---|---|---|
| Product name | Substitution (DS) | (meq/gm) | (Dalton) |
| JAGUAR ® | 0.17-0.20 | 0.9-1.1 | Approx. |
| C17 guar | | | 2M |
| JAGUAR ® | 0.10-0.13 | 0.6-0.7 | Approx. |
| C14S guar | | | 2M |
| JAGUAR ® | 0.09-0.14 | 0.6-0.75 | <1M |
| C500 guar | | | |
| JAGUAR ® | 0.10 | 0.5 | Approx |
| C162 guar | | | 1.5M |

Procedure for the Preparation of Fabric Conditioning Compositions
1. A guar, water and additives (if any) were added into a first beaker, then heated up to 55° C. with stirring.
2. TEP was melt in a second beaker at 55° C. and then added into the first beaker, then the mixture was agitated for at least 5 mins.
3. The mixture of step (2) was cooled down to 35° C. and preservatives and fragrance were added into the mixture.
4. The pH value of the mixture was adjusted to target value with 10 wt % NaOH water solution.

Procedure for Stability Test

Samples were incubated in an oven at 45° C. The samples were taken out and cooled down to room temperature once observation or test is needed. The samples were observed once or twice every week and the time points when phase segregation occurred in the samples were recorded.

### Example 1 and Comparative Examples 1 to 3

TABLE 2

| | | | |
|---|---|---|---|
| Ex. 1 | Com. Ex. 1 | Com. Ex. 2 | Com. Ex. 3 |

Component (wt %)

| | | | | |
|---|---|---|---|---|
| TEP | 2 | 2 | 2 | 2 |
| JAGUAR ® | 0.5 | | | |
| C17 guar | | | | |
| JAGUAR ® | | 0.5 | | |
| C14S guar | | | | |
| JAGUAR ® | | | 0.5 | |
| C500 guar | | | | |
| JAGUAR ® | | | | 0.5 |
| C162 guar | | | | |
| pH | 3.52 | 3.52 | 3.58 | 3.57 |
| Stability | >12 wks | 2-3 wks | <1 wk | 1 wk |

As shown in Table 2, the sample comprising TEP and JAGUARS C17 guar (Example 1) exhibited excellent stability and remained homogeneous for more than 4 weeks, notably, for at least 12 weeks, without any phase segregation occurring. In comparison, the samples comprising TEP in combination with one of JAGUAR® C14S guar (Com. Ex. 1), JAGUAR® C500 guar (Com. Ex. 2) and JAGUAR® C162 guar (Com. Ex. 3) exhibited unsatisfying stability and phase segregation occurred within 3 weeks in these samples.

### Example 2 and Comparative Examples 4-6

TABLE 3

| | | | |
|---|---|---|---|
| Ex. 2 | Com. Ex. 4 | Com. Ex. 5 | Com. Ex. 6 |

Component (wt %)

| | | | | |
|---|---|---|---|---|
| TEP | 2 | 4 | 2 | 4 |
| JAGUAR ® | 0.5 | 0.2 | | |
| C17 guar | | | | |
| JAGUAR ® | | | 0.5 | 0.2 |
| C14S guar | | | | |
| pH | 3.52 | 3.46 | 3.52 | 3.38 |
| Stability | >12 wks | 2-4 wks | 2-4 wks | 2-4 wks |

As shown in Table 3, the sample comprising TEP and JAGUAR® C17 guar, the weight ratio of the TEP and the JAGUAR® C17 guar being 4:1 (Ex. 2), remained homogeneous for more than 4 weeks, notably for at least 12 weeks, without any phase segregation occurring, showing markedly enhanced stability and prolonged storage time compared to comparative samples. The sample comprising TEP and JAGUAR® C17 guar, the weight ratio of the TEP and the JAGUAR® C17 guar being 20:1 (Com. Ex. 4) exhibited unsatisfying stability and phase segregation occurred within 4 weeks in this sample. Also, samples comprising TEP and JAGUAR® C14S guar (Com. Ex. 5 and 6) exhibited unsatisfying stability and phase segregation occurred within 4 weeks in these samples.

1-16. (canceled)

17. A method for enhancing the stability of a composition comprising the steps of adding in the composition:
a) a quaternary ammonium compound; and
b) a cationic polysaccharide having a charge density in the range of 0.8 to 3 meq/gm;
wherein the weight ratio of compound a) to compound b) is in the range of 1:1 to 15:1.

18. The method according to claim 17, wherein the compound a) has a charge density in the range of 0.8 to 1.6 meq/gm.

19. The method according to claim 17, wherein the compound a) has a charge density in the range of 0.9 to 1.4 meq/gm.

20. The method according to claim 17, wherein the weight ratio of the compound a) to the compound b) is in the range of 3:1 to 14:1.

21. The method according to claim 17, wherein the weight ratio of the compound a) to the compound b) is in the range of 4:1 to 13:1.

22. The method according to claim 17, wherein the weight ratio of the compound a) to the compound b) is in the range of 4:1 to 7:1.

23. The method according to claim 17, wherein the compound a) has the general formula (I):
[N⁺(R₁)(R₂)(R₃)(R₄)]_{y}X⁻ (I)
wherein:
R¹, R², R³ and R⁴, which may be the same or different, is a C₁-C₃₀ hydrocarbon group, optionally containing a heteroatom or an ester or amide group,
X is an anion, and
y is the valence of X.

24. The method according to claim 17, wherein the compound a) has the general formula (II):
[N⁺(R₅)₂(R₆)(R₇)]_{y}X⁻ (II)
wherein:
R⁵ is an aliphatic C₁₆₋₂₂ group,
R⁶ is a C₁-C₃ alkyl group,
R⁷ is R⁵ or R⁶,
X is an anion, and
y is the valence of X.

25. The method according to claim 17, wherein the compound a) has the general formula (III):
[N⁺((CH₂)ₙ-T-R₈)₂(R₈)(R₉)]X⁻ (III)
wherein:
R⁹ group is independently selected from C₁-C₄ alkyl or hydroxylalkyl group,
R⁸ group is independently selected from C₁-C₃₀ alkyl or alkenyl group,
T is —C(═O)—O—,
n is an integer from 0 to 5, and
X is an anion.

26. The method according to claim 17, wherein the compound a) has the general formula (IV):
N⁺(C₂H₄—OOCR₁₀)₂(CH₃)(C₂H₄—OH)CH₃SO₄⁻ (IV)
wherein R₁₀ is a C₁₂-C₂₀ alkyl chain.

27. The method according to claim 17, wherein the compound a) is selected from the group consisting of:
TET: Di(tallowcarboxyethyl)hydroxyethyl methyl ammonium methylsulfate,
TEO: Di(oleocarboxyethyl)hydroxyethyl methyl ammonium methylsulfate,
TES: Distearyl hydroxyethyl methyl ammonium methylsulfate,
TEHT: Di(hydrogenated tallow-carboxyethyl)hydroxyethyl methyl ammonium methylsulfate,
TEP: Di(palmiticcarboxyethyl)hydroxyethyl methyl ammonium methylsulfate,
DEEDMAC: Dimethylbis[2-[(1-oxooctadecyl)oxy]ethyl]ammonium chloride,
DHT: Dihydrogenated tallowdimethylammonium chloride, and mixtures thereof.

28. The method according to claim 17, wherein the compound b) is a cationic guar.

29. The method according to claim 17, wherein the compound b) is guar hydroxypropyltrimonium chloride, hydroxypropyl guar hydroxypropyltrimonium chloride, and mixtures thereof.

30. The method according to claim 17, wherein the composition comprises from 0.2 wt % to 2 wt % of the compound b), based on the total weight of the composition.

31. The method according to claim 17, wherein the compound b) has an average molecular weight (Mw) between 1,500,000 daltons and 3,500,000 daltons.

32. The method according to claim 17, wherein the composition does not show phase separation for at least 4 weeks when kept at 45° C.
